(19) United States
(12) Patent Application Publication
(10) Pub. No.: US 2007/0128407 A1
(43) Pub. Date: Jun. 7, 2007

(54) Silicone-coated furniture

(76) Inventor: Helen Kerr, Toronto (CA)

Correspondence Address: William B. Patterson;PATTERSON & SHERIDAN, LLP, Suite 1500, 3040 Post Oak Blvd., Houston, TX, 77056, US

(21) Appl. No.: 11/295,950

(22) Filed: Dec. 7, 2005

(51) Int. Cl. B32B 3/10

(52) U.S. Cl. 428/138

(57) ABSTRACT

The invention provides a method of laminating a furniture item with silicone elastomer, having a cured Shore hardness of at least about 10. A silicone-laminated furniture item is also provided. The furniture item may be used in high-traffic areas, and is expected to have particular application in health care and other institutional environments.

### BACKGROUND OF THE INVENTION

1. Field of the Invention

The invention relates to laminated furniture and more particularly to furniture for use in high-traffic areas, such as institutional or health care settings.

Silicones are a family of inorganic polymers which feature a silicon-oxygen backbone with side groups attached to the silicon atoms. Silicones, while generally flexible and translucent, can be formulated to have different densities and textures. Silicones may be in liquid, gel or solid form. Silicones have been used successfully in many consumer and industrial products, from baby bottle nipples to flexible bake wear to surgical implants to food additives and industrial adhesives.

### SUMMARY OF THE INVENTION

Silicone has not, to the applicant's knowledge, previously been used as a furniture laminate. In an elastomer form, silicone has a lovely soft feel which would make a comfortable surface for sitting on or resting against.

It is an aspect of the invention to provide a method of laminating a furniture item for high-traffic use. A layer of silicone elastomer is applied to the furniture item in cured or liquid state to sealingly cover at least the surfaces of the furniture item exposed to human contact. Then, if uncured, the silicone elastomer is allowed to cure. Preferably, the silicone elastomer has a cured Shore hardness of at least about 10. Preferably, the silicone elastomer has a minimum finished thickness of about 1 mm.

The terms “laminate” and “laminating” are used herein to mean that the silicone elastomer acts as a separate layer disposed on the furniture item. The silicone elastomer layer and the furniture item may be joined together chemically, mechanically or by some other factor. It is not intended that the invention be limited to any particular type of bond or engagement between the surface of the furniture item and the silicone elastomer. Likewise, the term “sealingly” is intended to mean only that the surface itself is sealed (i.e. generally impervious), not that the laminate is joined to the furniture item in any specific sealing engagement.

In one embodiment of the method, overmolding is used to apply the silicone elastomer to at least one portion of the furniture item. The silicone elastomer is then allowed to cure.

In another embodiment of the method, a measured amount of silicone elastomer is compression molded and pre-cured as a sheet. That sheet is then applied to at least one portion of the furniture item; and then mechanically or chemically secured to the furniture item. For instance, the “sheet” of silicone elastomer may be molded like a bag or envelope, which is then draped or wrapped or otherwise positioned on the furniture item. To give another example, the silicone elastomer may be formed like a shower cap, which is then fitted over the seat pan (or back, or some combination). The loose edges of the cap (or sheet) may be simply left loose, or they may be tucked in to some corresponding part of the furniture item (preferably, away from the human contact surfaces), or they may be secured by one or more secondary pieces of hardware (such as fastening devices, or plates, or other reinforcements). Most standard adhesives will not readily bond to silicone. However, it is contemplated that some chemical form of bonding may also be used for the securing.

In a still further embodiment of the method, a pre-cured silicone elastomer sheet may be cut or shaped to a particular size or shape; wrapped around at least one portion of the furniture item; and mechanically or chemically secured to the furniture item.

A wide range of possible formulations may be used for the silicone elastomer in the method to obtain suitable results as a furniture laminate. Preferably, the cured silicone elastomer should have a soft, non-sticky feel and a matte finish. In practice, the finished appearance may be either matte or shiny, but shiny appearance may be coincident with stickiness in silicones, and it is desirable that the silicone elastomer should not be sticky to the touch. The silicone elastomer may be translucent or opaque. It may be colored or pigmented.

A laminated furniture item is also provided in accordance with the method. The furniture item may be any of the following: a chair, a stool, a footrest, an ottoman, a bench, a sofa, a cushion, a table, a nightstand, a desk, a bed, a backrest, or any accessory or part therefor.

The laminated furniture item may be for use in an institutional setting, particularly a health care setting. However, it is imagined that the laminated coating would make the laminated furniture suitable for almost any type of environment, and particularly high-traffic use. “Institutional” should be read here with the widest possible meaning, including (without limitation): public seating/waiting areas (such as in hospitals, clinics, bus/train depots, shopping malls, offices, airports, schools, arenas) and areas where any type of physical treatment, therapy, examination or exercise is usually carried out (such as gyms, sports facilities, medical, dental or other clinical facilities, laboratories, spas, aesthetic treatment facilities, rehabilitation/treatment facilities, child care facilities, weight loss centers).

Furniture produced or treated according to the method may be made in various shapes, sizes and configurations. Considering the possible institutional uses of the furniture, it may be desirable to manufacture such items in bariatric sizes (for use with very large or obese people).

Apart from the method, it is another aspect of the invention to provide a laminated furniture item for high-traffic use. A furniture item body has a layer of silicone elastomer sealingly covering at least the surfaces exposed to human contact. The silicone elastomer preferably has a cured Shore hardness of at least 10, and a thickness of at least about 1 mm. The furniture item preferably has a contact surface comprising air flow perforations. The silicone elastomer layer extends through without filling the perforations. This perforated contact surface may be any surface of the furniture item. For instance, the contact surface may be a seat pan, a back rest, or an arm rest. However, the furniture item is not limited to a chair, and these particular surfaces are not critical.

One or more surfaces of the (unlaminated) furniture item may be uneven or textured. For instance, the seat pan may have an uneven or textured surface. In one embodiment, the silicone elastomer layer of the laminated furniture item has a smooth top surface which does not visually replicate the uneven or textured surface. This may provide a separate internal landscape that is touch-perceptible when the silicone elastomer layer is compressed. Such a surface may have many benefits (both functional and aesthetic). One such benefit may be to provide pressure relief while sitting. This feature may also be provided in combination with the aforementioned perforations.

In a further aspect of the invention, a health care furniture item is provided with the foregoing features. In addition to these features, it is contemplated that the formulation and thickness of the silicone elastomer being used would be especially selected to provide a fluid-impervious coating on the furniture item, and to inhibit proliferation and propagation of fungi, viruses, bacteria and other communicable or infectious agents on the furniture item. The formulation and thickness may also be especially selected for ease of cleaning and disinfection.

A particular embodiment of the health care furniture item is a health care chair. The chair may have many variations and configurations, including (without limitation) a standalone chair, a ganged chair configuration, a legged chair, a chair on a beam, a chair on a base with wheels. The chair may have arm rests. For health care use, the arm rest may be movably connected to the chair body to permit stowing the arm rest when not in use, or to provide clear access to a patient seated in the chair.

### BRIEF DESCRIPTION OF THE DRAWINGS

FIG. 1 shows a portion of a laminated chair according to an embodiment of the present invention.

FIG. 2 shows a cut-through view of a chair seat portion showing interior construction according to one embodiment.

FIG. 3 shows a portion of a laminated chair according to a bariatric embodiment.

FIG. 4 shows a laminated chair with base.

FIG. 5 shows a laminated chair with base and having optional arm rest features.

FIG. 6 shows another view of a laminated chair according to a bariatric embodiment.

FIG. 7 shows a laminated stool with wheeled base.

FIG. 8 shows laminated chairs in a ganged embodiment.

### DETAILED DESCRIPTION

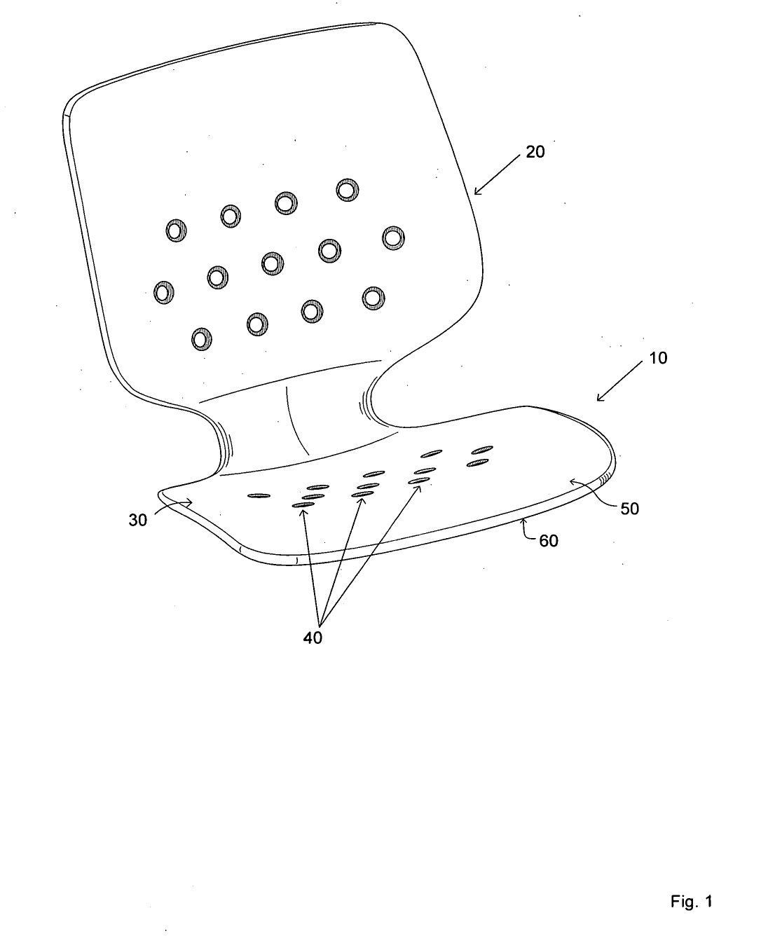

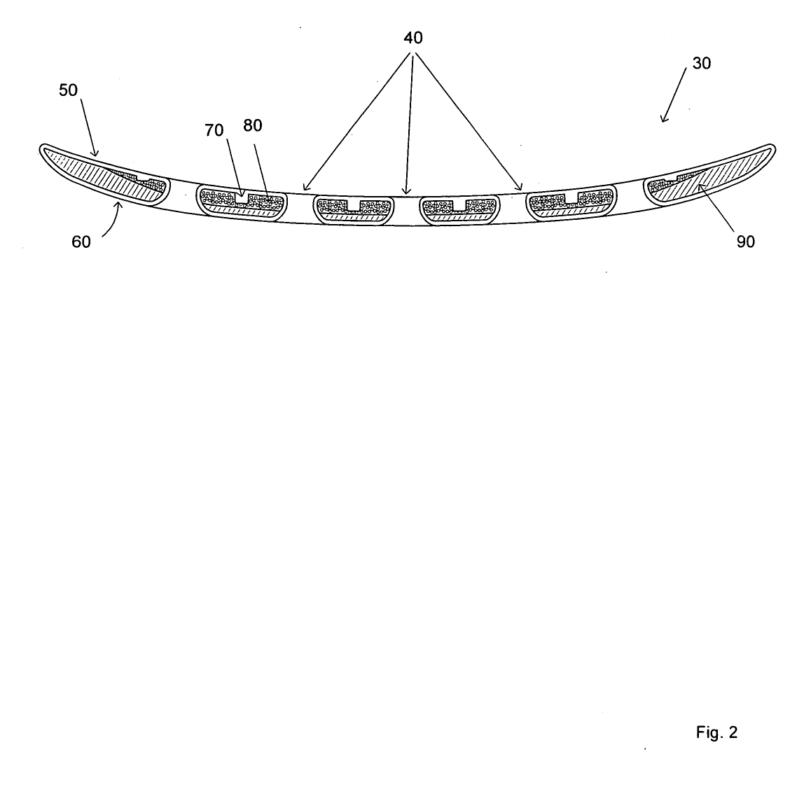

The present invention relates to laminated furniture and more particularly to furniture items laminated with silicone elastomer for use in high-traffic areas. As shown in FIG. 1, a basic embodiment of the invention is a chair. The chair may have a unitary back 20 and seat 30 construction as shown, or may be in separate pieces. Surfaces of the chair that are exposed to human contact (such as the seat pan portion 30) are laminated with silicone elastomer 70 as shown in FIG. 2. The seat portion 30 has a top surface 50 and a bottom surface 60. The entire chair back 20 and seat 30 may be laminated with silicone elastomer, or only the top and front surfaces thereof.

While silicone application can be accomplished in many ways (including rolling, spraying, calendaring, and other application processes), the following methods have been found particularly useful for furniture lamination in the present invention:
1. Overmolding the furniture item (or portions thereof) with silicone elastomer in a liquid form;
2. Fitting a compression molded sheet of pre-cured silicone elastomer over or onto the furniture item; or
3. Cutting or shaping a pre-cured sheet of silicone elastomer to a desired size and shape, and fitting the sheet over or onto the furniture item.

In the first method, the furniture item is placed in a specially constructed mold and liquid silicone elastomer is injected through one or more gates to coat the item to a desired thickness. Depending on the formulation of the silicone elastomer, curing may be at ambient temperature, or the silicone elastomer may be heat-cured or cured with a curing agent. In one possible embodiment, the silicone may be platinum cured liquid silicone. In its liquid state, the silicone elastomer flows around and into all of the surface features of the furniture item, including all holes and bosses. The finished surface of the silicone elastomer may be controlled by polishing or roughening the interior surface in the mold. The surface can be made to have a shiny or matte finish, and various surface textures may also be produced. The silicone elastomer itself may have additives such as stiffeners, colorants (pigments), or anti-static agents to change the look, feel or performance of the finished product.

The mold itself may be specially tailored for large scale application of liquid silicone elastomer. Depending on the formulation, care may need to be taken to prevent air entrainment (bubbles). Thermal expansion may also be a concern.

The bond between the silicone elastomer and the furniture substrate may be mechanical or chemical. It may be necessary or desirable, depending on the substrate and the formulation of the silicone, to prime the surfaces of the furniture item to be overmolded. A chemical primer may be used for this purpose. There are many suitable materials for the furniture item substrate. Some examples are metal, wood and molded plastic. Useful plastics include graphite epoxy composite and PBT-PC.

Preferably, the finished thickness of the silicone elastomer layer for the present application will be variable. On average, the thickness may be between about 1 to 2 mm. The layer may be made intentionally thicker in localized areas (4 mm+), such as around edges, for improved comfort or wear. Below about 1 mm, the laminate may be too thin to have a protective benefit, and may tear or fray in high use. Above a certain thickness, the silicone material may make the finished item too heavy, or the item may be prohibitively expensive to manufacture.

The desired “feel” characteristics of the laminate can be controlled by using different formulations of the silicone elastomer. A silicone elastomer formulation that has a cured Shore hardness in the range of 10 to 80 provides a sufficiently soft feel for sitting comfort. However, higher durometer ranges are possible without a loss of functionality. In certain formulations and surface finishes, it may be necessary to have another material as an overlay to prevent sticking, although recognizing that this may defeat the hygienic benefit and clean look of the exposed silicone, which are desirable for the present invention.

The second method for applying silicone elastomer uses a compression molded (pre-cured) sheet (or bag) of silicone elastomer that is draped or enveloped over the furniture item (or surface) to be coated. To retain the sheet on the furniture item, a reinforcement plate (not shown) or other hardware may be used to secure the edges (for example, on the back surface of the back support or on the underside of the seat pan). In one possible embodiment, the compression molded silicone is a peroxide cured high consistency silicone rubber.

This second method may be particularly useful for larger items, which may be difficult or impossible to overmold (or cost-prohibitive). Larger-scale chairs (such as those for bariatric users), tables, beds, etc. may be laminated using this second method.

A third method is also possible, which uses cut or shaped sheets of silicone elastomer. This may be particular useful to cover large, flat surfaces. Additional hardware may be used to attach the sheets to the furniture item, or the sheets may be chemically bonded.

Turning to FIG. 2, the silicone elastomer may be in conjunction with a textured or irregularly surfaced substrate 80. For instance, the textured substrate may have a dimpled or ridged surface. The applicant has also found that a useful seating structure can be provided by combining two different densities of silicone. Over a hard plastic shell 90, an irregular layer of silicone foam may be provided, and silicone elastomer 70 provided over and/or around the irregular foam surface. Preferably, the top surface 50 is visually smooth and flat betraying no surface irregularity. When the silicone elastomer is compressed (such as by sitting on the seat), preferably the irregular surface will be perceived by feel. According to one possible configuration, the interior landscape of the seat may be textured to have the feel (without the look) of a dimpled or beaded surface. The raised lands or dimples may be particularly designed to optimize comfort and pressure relief, so as to prevent decubitis sores. It will be appreciated that the textured foam interlayer may be replaced with another material or eliminated altogether. The plastic shell itself may have a textured surface.

As shown in FIGS. 1-3, the seat portion 30 and/or the back portion 20 may be provided with throughholes (perforations) 40 for air flow (breathability) and moisture egress. The holes extend through the seat portion and/or back portion and are preferably coated on the inside with the silicone elastomer laminate. Any shape and configuration of holes may be provided. (Buildup of moisture may be a particular concern in health care and institutional settings, where patients may be bleeding or experiencing other fluid loss.) Silicone is moisture impervious.

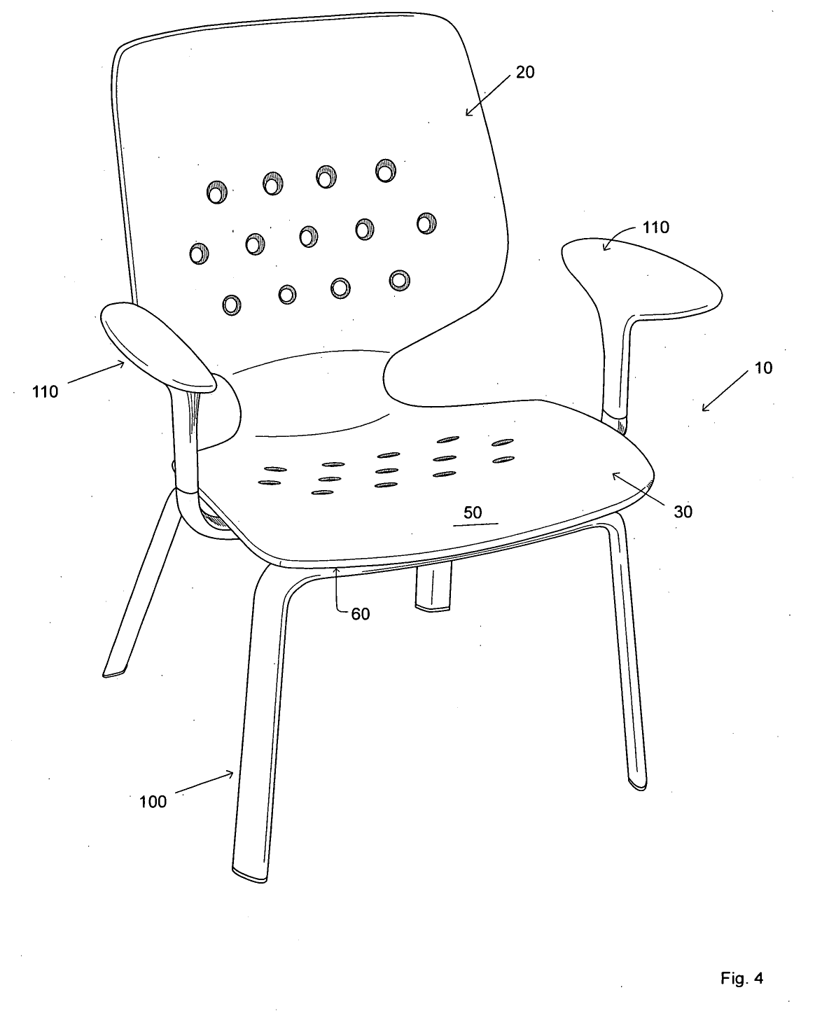

Preferably, as shown in FIG. 4, the chair 10 may be assembled in a standard stacking chair format, having a standard base with legs 100. The base may or may not be coated with the silicone elastomer.

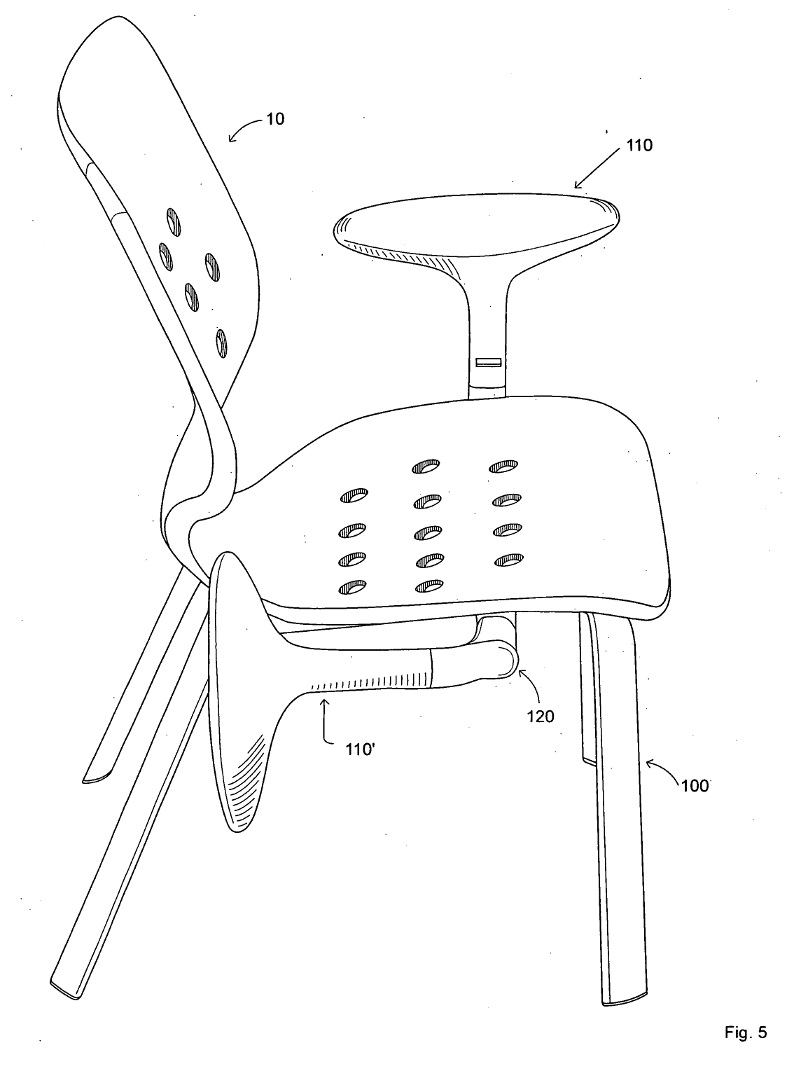

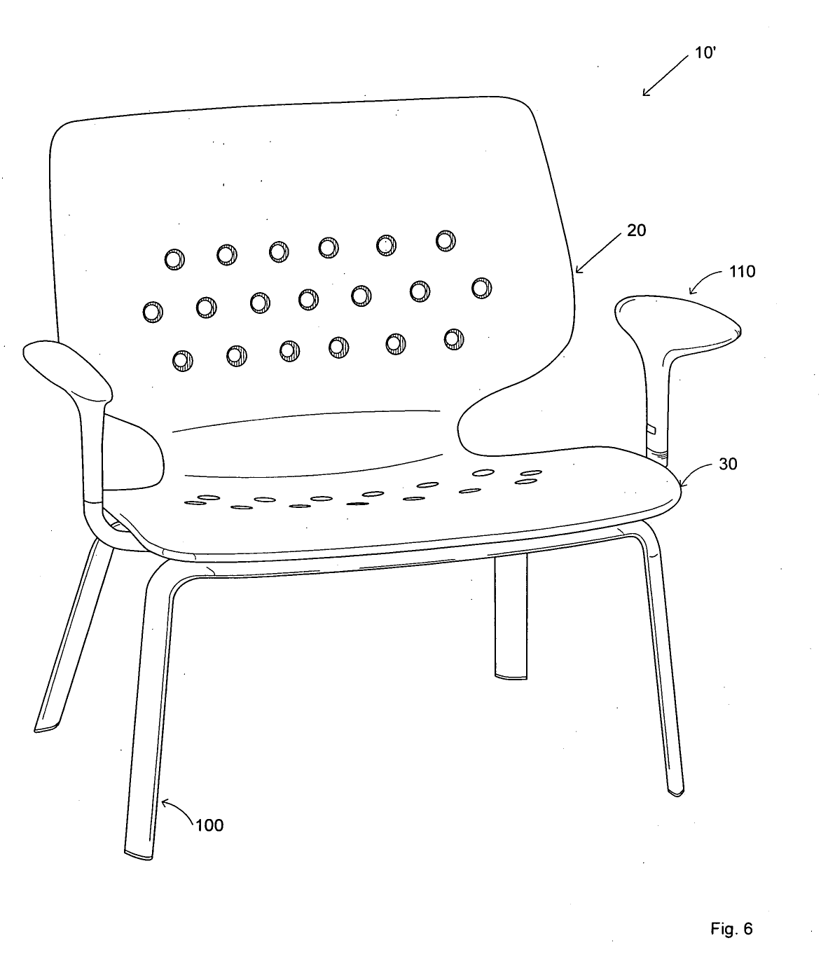

Arm rests 110 may be provided as shown in FIGS. 4 and 6 (laminated or not). Arm rests may be provided with an optional swing-away design as shown in FIG. 5. In this variant, the arm rest 110′ may be rotated or swiveled at joint 120 to clear or stow it away from the central sitting region of the chair (down, back or to the side). In an institutional or health care setting, this feature may be particularly useful for patient access.

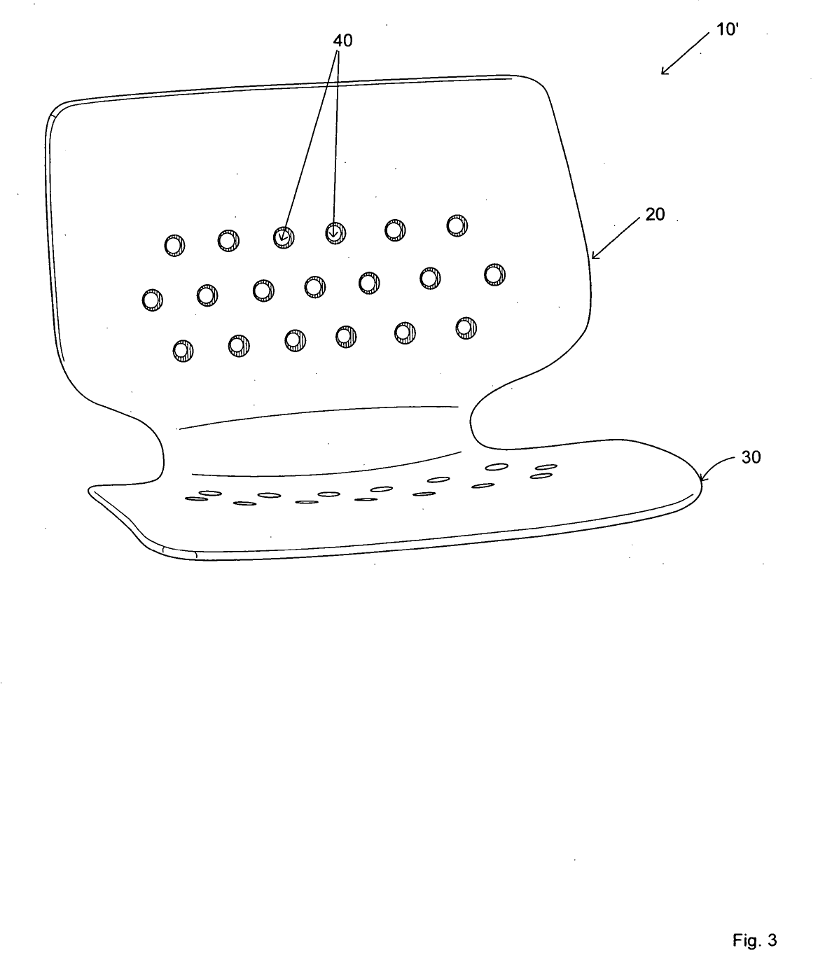

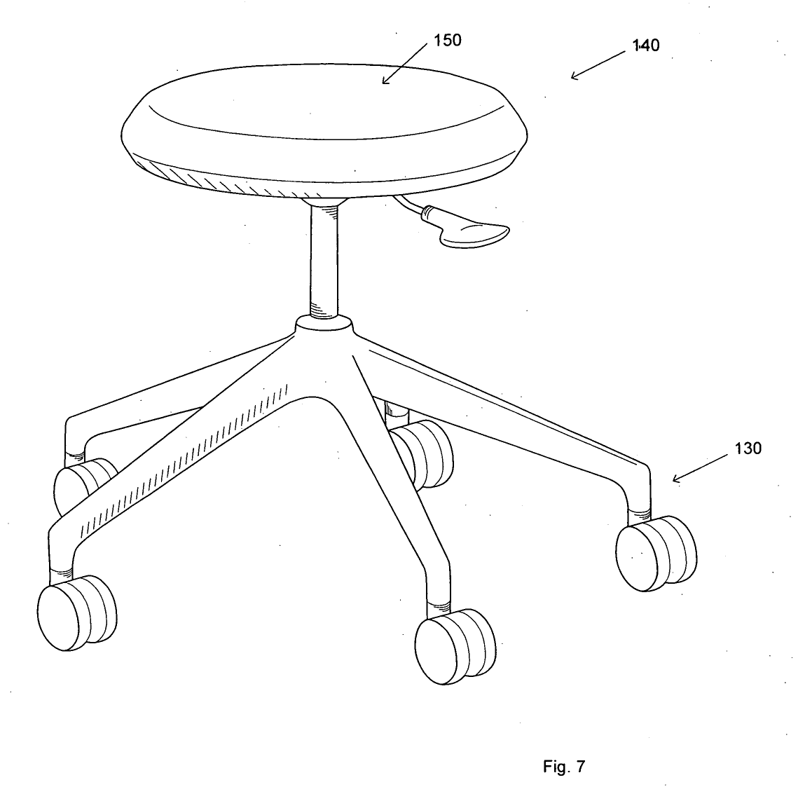

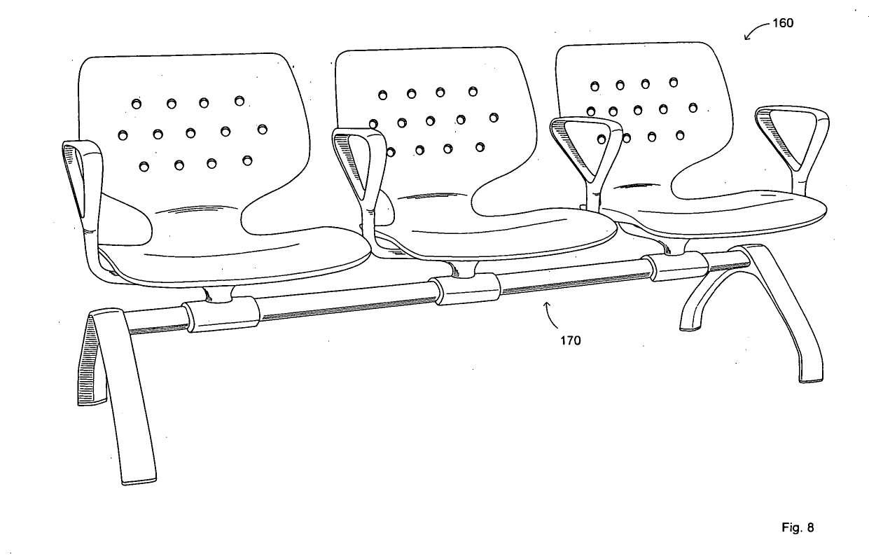

Many size and configuration variations of the laminated chair are possible. The chair may be provided in a “bariatric” size 10′ (to accommodate very large or obese people), as shown in FIG. 3 and 6. Backless chairs and stools may be provided, such as the stool configuration 140 shown in FIG. 7. The stool top 150 may be the laminated portion, or the entire stool, including base 130, may be laminated. Chairs may also be provided in standalone or ganged 160 variations on a beam base 170 (such as shown in FIG. 8). It will be appreciated that the process is also not limited to chairs and other “seating” furniture (such as sofas, benches, and the like), but may also apply to other furniture items, such as beds, tables, foot rests, cushions, etc.

In the health care and institutional context, specialty furniture may be laminated, such as examining tables, patient support furniture and equipment (crutches, walkers, canes), wheelchairs, toilet seats, potty chairs, bed rails, and others.

In a health care and institutional context, the silicone coating is particularly useful as the silicone has naturally inert properties. It is resistant to bacteria, viruses, and fungi, and water-impervious. Also, unlike fabric or mesh furniture coverings, the silicone will not fray or become worn in use. It has an easy-care surface which wipes clean with simple soap and water, but it will also hold up against harsh cleansers and chemical washes. Where smoking is permitted, ash burns can develop on conventional furniture. Silicone is naturally resistant to high heat and will not burn from cigarette ash.

The foregoing description illustrates only certain preferred embodiments of the invention. The invention is not limited to the foregoing examples. That is, persons skilled in the art will appreciate and understand that modifications and variations are, or will be, possible to utilize and carry out the teachings of the invention described herein. Accordingly, all suitable modifications, variations and equivalents may be resorted to, and such modifications, variations and equivalents are intended to fall within the scope of the invention as described and within the scope of the claims.

While the foregoing is directed to embodiments of the present invention, other and further embodiments of the invention may be devised without departing from the basic scope thereof, and the scope thereof is determined by the claims that follow.

1. A method of laminating a furniture item for high-traffic use comprising:
applying a layer of silicone elastomer to the furniture item in cured or liquid state to sealingly cover at least the surfaces of the furniture item exposed to human contact, and, if uncured, allowing the silicone elastomer to cure,
wherein the silicone elastomer has a cured Shore hardness of at least about 10.

2. The method of claim 1, wherein the silicone elastomer has a minimum finished thickness of about 1 mm.

3. The method of claim 1, wherein the applying step comprises overmolding at least one portion of the furniture item with the silicone elastomer and allowing the silicone elastomer to cure.

4. The method of claim 1, wherein the applying step comprises applying at least one compression molded and pre-cured sheet of silicone elastomer to at least one portion of the furniture item; and mechanically or chemically securing the at least one sheet to the furniture item.

5. The method of claim 1, wherein the applying step comprises:
cutting or shaping a sheet of pre-cured silicone elastomer;
wrapping the sheet around at least one portion of the furniture item; and
mechanically or chemically securing the sheet to the furniture item.

6. The method of claim 1, wherein the cured silicone elastomer has a soft, non-sticky feel.

7. The method of claim 1, wherein the cured silicone elastomer has a matte appearance.

8. The method of claim 1, wherein the cured silicone elastomer is translucent.

9. The method of claim 1, wherein the cured silicone elastomer is opaque.

10. The method of claim 1, wherein the silicone elastomer is colored or pigmented.

11. A laminated furniture item made according to the method set out in claim 1.

12. The laminated furniture item of claim 16, wherein the furniture item is selected from the group consisting of a chair, a stool, a footrest, an ottoman, a bench, a sofa, a cushion, a table, a nightstand, a desk, a bed, a backrest, and any accessory or part therefor.

13. The laminated furniture item of claim 16, wherein the furniture item is for use in an institutional setting.

14. The laminated furniture item of claim 16, wherein the furniture item is for use in a health care setting.

15. The laminated furniture item of claim 16, wherein the furniture item is sized for bariatric use.

16. A laminated furniture item for high-traffic use comprising:
a furniture item body having a layer of silicone elastomer sealingly covering at least the surfaces of the furniture item exposed to human contact,
wherein the silicone elastomer has a cured Shore hardness of at least 10, and wherein the layer of silicone elastomer has a thickness of at least about 1 mm.

17. The laminated furniture item of claim 16, wherein the furniture item has a contact surface comprising air flow perforations, and wherein the silicone elastomer layer extends through without filling the perforations.

18. The laminated furniture item of claim 17, wherein the contact surface is a seat pan.

19. The laminated furniture item of claim 17, wherein the contact surface is a back rest.

20. The laminated furniture item of claim 17, wherein the contact surface is an arm rest.

21. The laminated furniture item of claim 16, wherein the furniture item comprises a seat portion having an uneven or textured surface.

22. The laminated furniture item of claim 21, wherein the silicone elastomer layer has a smooth top surface which does not visually replicate the uneven or textured surface of the seat portion.

23. The laminated furniture item of claim 22, wherein the uneven or textured surface comprises an internal landscape that is touch-perceptible when the layer is compressed.

24. The laminated furniture item of claim 21, wherein the furniture item is adapted for pressure relief while sitting.

25. The laminated furniture item of claim 21, wherein the seat portion further comprises air flow perforations, the silicone elastomer layer extending through without filling the perforations.

26. A health care furniture item comprising:
a furniture item body having a layer of silicone elastomer sealingly covering at least the surfaces of the furniture item exposed to human contact,
wherein the silicone elastomer has a cured Shore hardness of at least 10, and a thickness of at least about 1 mm,
the formulation and thickness of silicone elastomer being selected to provide a fluid-impervious coating on the furniture item, and to inhibit proliferation and propagation of fungi, viruses, bacteria and other communicable or infectious agents on the furniture item.

27. The health care furniture item of claim 26, wherein the formulation and thickness of silicone elastomer is further selected for ease of cleaning.

28. The health care furniture item of claim 26, wherein the formulation and thickness of silicone elastomer is further selected for ease of disinfection.

29. A health care chair comprising:
a chair body having a layer of silicone elastomer sealingly covering at least the surfaces of the chair exposed to human contact,
wherein the silicone elastomer has a cured Shore hardness of at least 10, and a thickness of at least about 1 mm,
the formulation and thickness of silicone elastomer being selected to provide a fluid-impervious coating on the chair, and to inhibit proliferation and propagation of fungi, viruses, bacteria and other communicable or infectious agents on the chair.

30. The health care chair of claim 29, wherein the chair comprises a standalone chair.

31. The health care chair of claim 29, wherein the chair comprises a ganged chair configuration.

32. The health care chair of claim 29, wherein the chair comprises a legged chair.

33. The health care chair of claim 29, wherein the chair comprises a chair on a beam.

34. The health care chair of claim 29, wherein the chair comprises a chair on a base with wheels.

35. The health care chair of claim 29, wherein the chair has arm rests.

36. The health care chair of claim 35, wherein at least one arm rest is movably connected to the chair body to permit stowing the arm rest when not in use, or to provide clear access to a patient seated in the chair.
